(19) United States
(12) Patent Application Publication
(10) Pub. No.: US 2007/0177494 A1
(43) Pub. Date: Aug. 2, 2007

(54) CELLULAR RADIO COMMUNICATION SYSTEM, BASE STATION, RADIO TERMINAL AND RADIO COMMUNICATION METHOD

(75) Inventor: Takeshi TOMIZAWA, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-ku (JP)

(21) Appl. No.: 11/534,465

(22) Filed: Sep. 22, 2006

(30) Foreign Application Priority Data
Jan. 31, 2006 (JP) 2006-023257

(51) Int. Cl. H04J 11/00

(52) U.S. Cl. 370/208

(57) ABSTRACT

There is provided with a radio communication method in which an OFDMA scheme is used for communication from a base station to radio terminals, including: transmitting classification information for classifying the radio terminals under any one of a plurality of groups from the radio terminals to the base station; determining groups under which the radio terminals are to be classified; determining frequency channels to assign to the radio terminals; distributing slots to the groups; notifying each of the radio terminals of the control information representing a slot format, the channel assigned to the radio terminal and positions of slots; creating slot data including a plurality of symbol in each slot position; OFDM-modulating the respective symbols included in the slot data to generate a plurality of OFDM symbols; transmitting the plurality of OFDM symbols as OFDM slot data, from the base station to the radio terminals belonging to the group.

### CROSS-REFERENCE TO RELATED APPLICATIONS

This application is based upon and claims the benefit of priority from the prior Japanese Patent Applications No. 2006-23257 filed on Jan. 31, 2006, the entire contents of which are incorporated herein by reference.

### BACKGROUND OF THE INVENTION

1. Field of the Invention

The present invention relates to a cellular radio communication system, a base station, a radio terminal and a radio communication method.

2. Related Art

In a radio communication system using OFDM modulation, pilot symbols for use in timing synchronization and transmission path estimation are fixedly arranged, for example, only a few symbols on the head side in a slot. In this case, there is a problem that when, for example, a terminal is moving at a high speed, fading fluctuation occurs at a high speed and reception quality deteriorates.

Thus, JP-A 2001-77788 (KOKAI) discloses a configuration whereby when a parent station and a user perform one-to-one burst-like transmission, an arrangement and a proportion of transmission pilot signals are controlled according to a transmission path estimation scheme and type of transmission data.

However, JP-A 2001-77788 (KOKAI) does not disclose any case where a plurality of users are multiplexed as in the case of a cellular scheme. If the technique of JP-A 2001-77788 (KOKAI) is applied to a plurality of users, it is expected that burst data is transmitted to the respective users on a time-division basis. In this case, there is a problem that as the amount of burst data of one user increases, a standby time for data transmission to other users increases, causing a delay of stream data such as voice and moving images. On the contrary, when the size of burst data is decreased to reduce the delay, the number of blocks increases and the proportion of pilot signals in each block increases. This results in a problem of causing a decrease in the transmission capacity of the entire system.

### SUMMARY OF THE INVENTION

According to an aspect of the present invention, there is provided with a cellular radio communication system in which an OFDMA (Orthogonal Frequency Division Multiple Access) scheme is used for communication from a base station to radio terminals,

the base station comprising:

a reception section configured to receive classification information for classifying the radio terminals respectively under any one of a plurality of groups from the radio terminals;

a group determining section configured to determine groups under which the radio terminals are to be classified based on the classification information received;

a channel determining section configured to determine frequency channels to assign to the radio terminals;

a slot distribution section configured to distribute slots which are time frame of constant length to the groups;

a slot format storage configured to store slot formats for the groups, defining an arrangement of at least one pilot symbol for synchronization, at least one pilot symbol for transmission path estimation and data symbols for transmitting transmission data;

a notification section configured to notify each of the radio terminals of control information representing a slot format of the group under which the radio terminal is classified, the frequency channel assigned to the radio terminal and positions of slots distributed to the group under which the radio terminal is classified;

a slot creation section configured to create slot data at each slot position, including a plurality of symbol based on transmission data directed to radio terminals which belong to the group to which the slot position is assigned, information of the frequency channels assigned to the radio terminals in the group, data for synchronization specified beforehand, data for the transmission path estimation specified before hand and a slot format associated with the group;

an OFDM modulation section configured to OFDM-modulate the respective symbols included in the slot data created to generate a plurality of OFDM symbols; and

a transmission section configured to transmit the plurality of OFDM symbols as OFDM slot data, and

the radio terminal comprising:

a classification information creation section configured to create the classification information;

a transmission section configured to transmit the classification information created to the base station;

a control information acquisition section configured to acquire the control information from the base station;

a reception section configured to receive the OFDM slot data from the base station; and

an OFDM demodulation section configured to perform a fast Fourier transform on the respective OFDM symbols in the OFDM slot data received at slot positions indicated in the control information to separate the each OFDM symbol into a plurality of subcarriers, and carry out synchronization processing, transmission path estimation processing and demodulation processing according to the slot format indicated in the control information using subcarriers which belong to the frequency channel indicated in the control information.

According to an aspect of the present invention, there is provided with a base station which uses OFDMA (Orthogonal Frequency Division Multiple Access) scheme for communication to radio terminals, comprising:

a reception section configured to receive classification information for classifying the radio terminals respectively under any one of a plurality of groups from the radio terminals;

a group determining section configured to determine groups under which the radio terminals are to be classified based on the classification information received;

a channel determining section configured to determine frequency channels to assign to the radio terminals;

a slot distribution section configured to distribute slots which are time frame of constant length to the groups;

a slot format storage configured to store slot formats for the groups, defining an arrangement of at least one pilot symbol for synchronization, at least one pilot symbol for transmission path estimation and data symbols for transmitting transmission data;

a notification section configured to notify each of the radio terminals of control information representing a slot format of the group under which the radio terminal is classified, the frequency channel assigned to the radio terminal and positions of slots distributed to the group under which the radio terminal is classified;

a slot creation section configured to create slot data at each slot position, including a plurality of symbol based on transmission data directed to radio terminals which belong to the group to which the slot position is assigned, information of the frequency channels assigned to the radio terminals in the group, data for synchronization specified beforehand, data for the transmission path estimation specified before hand and a slot format associated with the group;

an OFDM modulation section configured to OFDM-modulate the respective symbols included in the slot data created to generate a plurality of OFDM symbols; and

a transmission section configured to transmit the plurality of OFDM symbols as OFDM slot data.

According to an aspect of the present invention, there is provided with a radio terminal which uses OFDMA (Orthogonal Frequency Division Multiple Access) scheme for communication from a base station, comprising:

a classification information creation section configured to create classification information for requesting classifying into any one of a plurality of group;

a transmission section configured to transmit the classification information created to the base station;

a reception section configured to receive OFDM slot data as a plurality of OFDM symbols from the base station; and

a control information acquisition section configured to acquire control information from the base station, wherein the control information indicates (A) a slot format associated with a group classified into by the base station which defines an arrangement of at least one pilot symbol for synchronization, at least one pilot symbol for transmission path estimation and data symbols for transmitting transmission data, (B) a frequency channel assigned by the base station, and (C) positions of slots which are time frame of constant length, distributed to said group;

an OFDM demodulation section configured to perform a fast Fourier transform on the respective OFDM symbols in the OFDM slot data received at slot positions indicated in the control information to separate the each OFDM symbol into a plurality of subcarriers respectively, and carry out synchronization processing, transmission path estimation processing and demodulation processing according to the slot format indicated in the control information using subcarriers which belong to the frequency channel indicated in the control information.

According to an aspect of the present invention, there is provided with a radio communication method in which an OFDMA (Orthogonal Frequency Division Multiple Access) scheme is used for communication from a base station to radio terminals, comprising:

transmitting classification information for classifying the radio terminals respectively under any one of a plurality of groups from the radio terminals to the base station;

determining groups under which the radio terminals are to be classified based on the classification information;

determining frequency channels to assign to the radio terminals;

distributing slots which are time frame of constant length to the groups;

notifying each of the radio terminals of the control information representing a slot format of the group under which the radio terminal is classified, the channel assigned to the radio terminal and positions of slots distributed to the group under which the radio terminal is classified, wherein the slot format defines an arrangement of at least one pilot symbol for synchronization, at least one pilot symbol for transmission path estimation and data symbols for transmitting transmission data;

creating slot data including a plurality of symbol in each slot position based on transmission data directed to radio terminals which belong to the group to which the slot position is assigned, information of the frequency channel assigned to radio terminals in the group, data for synchronization specified beforehand, data for the transmission path estimation specified before hand, and a slot format associated with the group;

OFDM-modulating the respective symbols included in the slot data to generate a plurality of OFDM symbols;

transmitting the plurality of OFDM symbols as OFDM slot data, from the base station to the radio terminals belonging to the group;

receiving the OFDM slot data transmitted from the base station at radio terminals;

receiving the control information transmitted from the base station at radio terminals;

performing a fast Fourier transform on the respective OFDM symbols in the OFDM slot data at slot positions indicated in the control information to separate the each OFDM symbol into a plurality of subcarriers; and

carrying out synchronization processing, transmission path estimation processing and demodulation processing according to the slot format indicated in the control information using subcarriers which belong to the frequency channel indicated in the control information.

### BRIEF DESCRIPTION OF THE DRAWINGS

FIG. 1 illustrates the configuration of a cellular radio communication system according to a first embodiment of the present invention;

FIG. 2 illustrates examples of use of the cellular radio communication system in FIG. 1;

FIG. 3 illustrates examples of a high-speed moving slot format and low-speed moving slot format;

FIG. 4 illustrates the configuration of a cellular radio communication system according to a second embodiment of the present invention;

FIG. 5 illustrates examples of a normal guard interval slot format and long guard interval slot format;

FIG. 6 illustrates the configuration of a cellular radio communication system according to a third embodiment of the present invention; and

FIG. 7 illustrates examples of a non-MIMO slot format MIMO and MIMO slot format.

### DETAILED DESCRIPTION OF THE INVENTION

Hereafter, embodiments according to the present invention will be described more specifically with reference to the drawings.

### First Embodiment

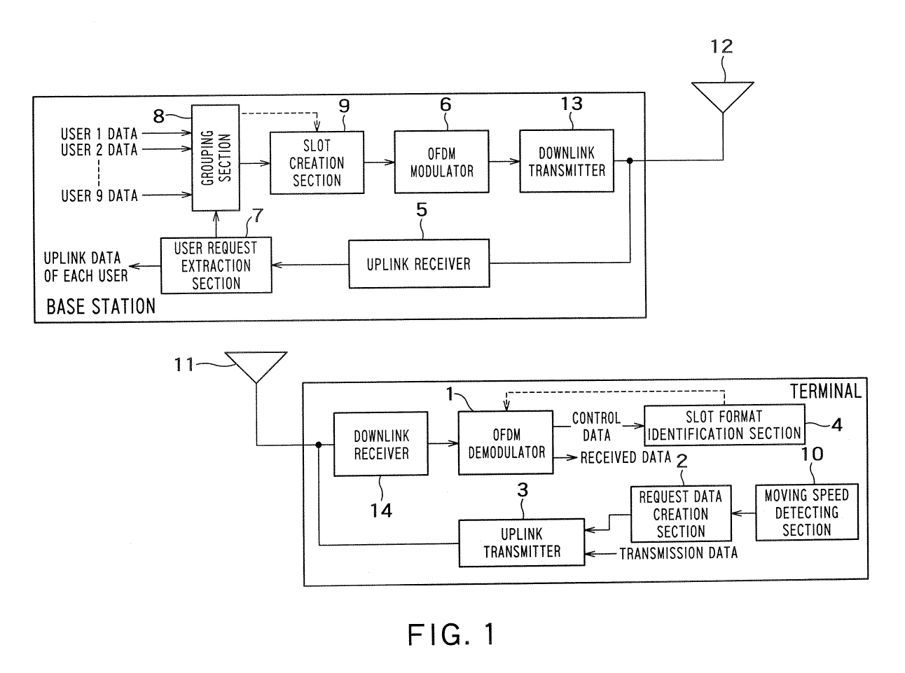

FIG. 1 illustrates the configuration of a cellular radio communication system according to a first embodiment of the present invention.

This cellular radio communication system is provided with a base station and a plurality of terminals. For simplicity of drawings, only one terminal is shown here. A communication from the base station to the terminal is performed according to OFDMA (Orthogonal Frequency Division Multiple Access) and a communication from the terminal to the base station is performed according to an arbitrary communication scheme.

The terminal is provided with a moving speed detecting section 10, a user request data creation section (classification information creation section) 2, an uplink transmitter 3, an antenna 11, an OFDM demodulator 1, a slot format identification section (control information acquisition section) 4 and a downlink receiver 14.

The moving speed detecting section 10 detects the moving speed of the terminal. The moving speed detecting section 10 detects the moving speed using, for example, position information of a Global Positioning System (GPS) or a gyro function by a Micro Electro Mechanical System (MEMS).

The user request data creation section 2 outputs numerical data indicating the moving speed of the detected terminal as user request data (classification information). Alternatively, the user request data creation section 2 judges to which of a plurality of groups (e.g., low-speed moving group and high-speed moving group) the terminal belongs based on the detected moving speed and outputs group identifier data indicating an identifier of the group to which the terminal belongs as user request data. For example, when the terminal and base station are in communication or when the terminal enters the area (cell) of the base station, the terminal receives threshold data from the base station and the user request data creation section 2 judges the group to which the terminal belongs based on the received threshold and detected moving speed. The threshold data may also be preset in the terminal.

The uplink transmitter 3 modulates user request data inputted from the user request data creation section 2 and transmission data (user data such as audio, video and packet and control data for transmitting control information to the base station) and further performs band limiting filtering, up-conversion and power amplification and transmits the data from the antenna 11. The user request data is transmitted, for example, as part of the control data.

The OFDM demodulator 1 is fed with signals from the base station (OFDM symbols corresponding to 1 slot) received by the antenna 11, subjected to down-conversion and band limiting processing by the downlink receiver 14. Here, the slot is time frame of constant length. The OFDM demodulator 1 performs OFDM demodulation processing on signals at the slot positions notified from the slot format identification section 4. More specifically, the OFDM demodulator 1 performs a Fast Fourier Transform (FFT) on the respective inputted OFDM symbols and separates them into a plurality of subcarriers respectively first. The OFDM demodulator 1 handles subcarriers which belong to a channel (frequency channel) to which the bearer used by itself (e.g., one data stream such as voice data stream or video data stream or the like) is assigned out of the separated subcarriers according to a slot format (which specifies a symbol arrangement pattern in one slot; details of which will be described later). For example, in the case of data symbols, data is modulated, user data (received data) is outputted to an application and control data is outputted to protocol software and the slot format identification section 4. Furthermore, in the case of synchronization pilot symbols which are pilot symbols for synchronization, synchronization processing is performed and in the case of transmission path estimation pilot symbols which are pilot symbol for transmission path estimation, transmission path estimation is performed.

The slot format identification section 4 checks whether or not there is a change to the slot format, slot position and channels (subcarriers) used by the own station based on the control data (group change information) inputted from the OFDM demodulator 1, and when there is a change, the information after the change is passed to the OFDM demodulator 1. The arrow of dotted line connecting the slot format identification section 4 with the OFDM demodulator 1 in the figure shows the flow of a control signal and this control signal includes notification of the information after the change.

The base station includes an antenna 12, an uplink receiver 5, a user request extraction section 7, a grouping section 8, a slot creation section 9, an OFDM modulator 6 and a downlink transmitter 13. The grouping section 8 includes, for example, a group determining section, a channel determining section, a slot distribution section, a slot format storage and a notification section.

The uplink receiver 5 demodulates the signals from the antenna 12 using a demodulation scheme corresponding to the modulation scheme used by the uplink transmitter 3 of the terminal and outputs the demodulated data.

The user request extraction section 7 extracts the user request data from the demodulated data, passes it to the grouping section 8 and passes data other than the user request data to a data processing section (not shown) in the subsequent stage, for example, a MAC processing section of a radio communication protocol or the like.

The grouping section 8 classifies a user (owner of the terminal) under any one of a plurality of groups (e.g., low-speed moving group and high-speed moving group) based on the user request data extracted from the user request extraction section 7. When the user request data is moving speed data, grouping is performed based on the moving speed data and a predetermined threshold. When the user request data is group identifier data, the user is classified under a group that corresponds to a group identifier. Each group is associated with its corresponding slot format.

Furthermore, the grouping section 8 calculates the distribution (the number of slots and slot positions) of slots to the respective groups. Furthermore, the grouping section 8 determines a channel (frequency channel) to which the bearer of each terminal should be assigned as channel information. Subcarriers belonging to one channel need not be identical for all symbols in one slot and may differ from one symbol to another. The channel information indicates more specifically the subcarriers assigned to the terminal expressed for each symbol in one slot.

The grouping section 8 stores information per group on terminals belonging to each group, information (channel information) on subcarriers assigned to each radio terminal belonging to the group, information on a slot format associated with each group and information on slot positions distributed to each group in a storage. The grouping section 8 notifies the grouped terminals of information of the slot format associated with the group to which the terminal belongs (e.g., identifier), slot position distributed to the group and channel information assigned to the terminal through the slot creation section 9, OFDM modulator 6, downlink transmitter 13 and antenna 12. That is, the grouping section 8 includes a notification section. Details of notification will be described later.

On the other hand, the grouping section 8 assigns each user's data per slot (user data, control data or the like) necessary to create slot to each user's channel, passes the data to the slot creation section 9 and also notifies the slot creation section 9 of the slot format applied to the group of this slot. Therefore, the data transmitted through one slot is only data of the user who belongs to the group. The arrow of dotted line in the figure shows the flow of a control signal from the grouping section 8 to the slot creation section 9 and this control signal includes a notification signal of the slot format. Note that groups need not be assigned to all slot positions and there can be free slots. Moreover, there can also be slots irrelevant to groups, for example, a slot targeted at all terminals within the range of the own station and a predetermined slot format is used.

The slot creation section 9 creates slot data made up of a plurality of pieces of symbol data based on the slot format notified from the grouping section 8 and each user's data assigned to each channel. That is, the slot creation section 9 arranges each user's data passed from the grouping section 8 for each FFT point of OFDM and also adds pilot data for timing synchronization and pilot data for transmission path estimation.

The OFDM modulator 6 OFDM-modulates each piece of symbol data included in the slot data created by the slot creation section 9 and generates a plurality of OFDM symbols. That is, the OFDM modulator 6 modulates each piece of symbol data according to a modulation multi-value number (modulation scheme) for each subcarrier to generate modulated signals, performs Inverse Fast Fourier Transform (IFFT) processing on the modulated signals generated and generates one OFDM symbol from one piece of symbol data. A set of OFDM symbols generated from the respective pieces of symbol data corresponds to “OFDM slot data.”

The downlink transmitter 13 performs up-conversion, power amplification, band limiting filtering on the each OFDM symbol signals included in the OFDM slot data generated by the OFDM modulator 6 and transmits the signals from the antenna 12.

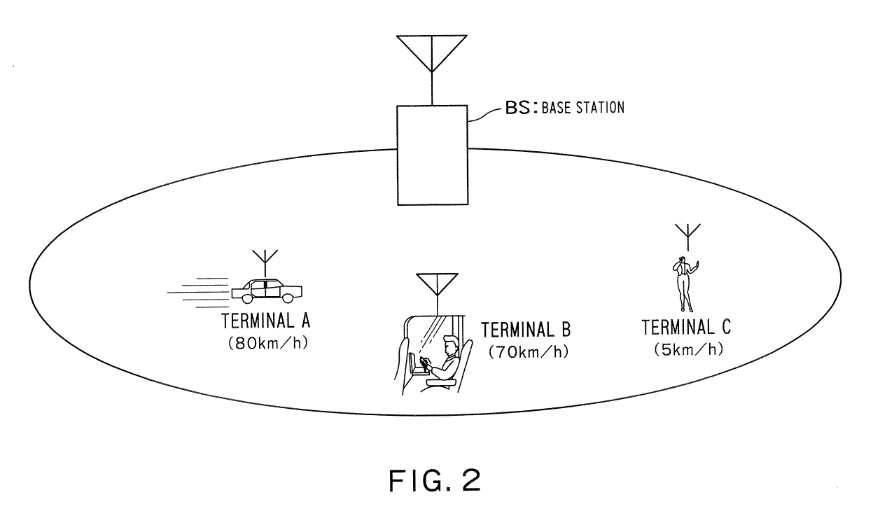

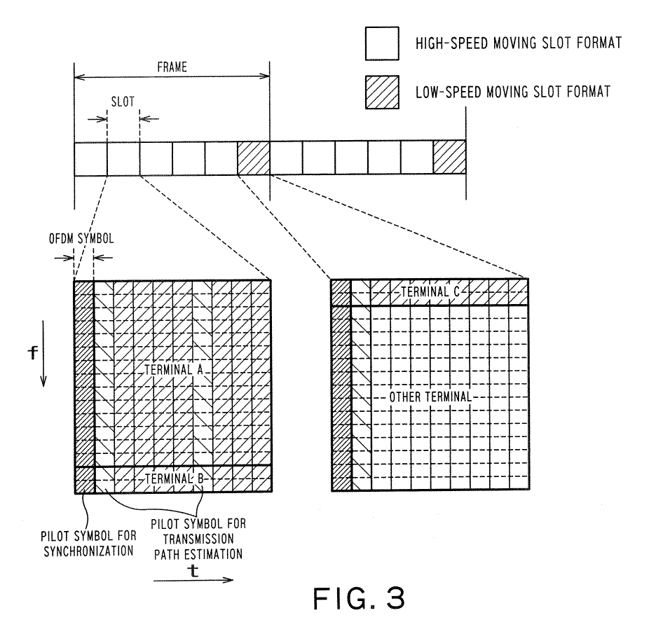

The cellular radio communication system in FIG. 1 will be explained in further detail using FIG. 1, FIG. 2 and FIG. 3.

FIG. 2 shows examples of use of the cellular radio communication system in FIG. 1.

A plurality of terminal A, terminal B, terminal C exist within a cell range covered by one base station BS. Suppose the terminal A, terminal B and terminal C are moving at 80 km/h, 70 km/h and 5 km/h respectively. Each terminal detects the base station BS when it enters the cell range of the base station, issues a connection request and is registered in the base station BS. Each of the terminals A, B and C is receiving communication services such as telephone calls and packet communication. The terminals A, B and C are always measuring the own moving speeds and report user request data to the base station BS as part of control data in an uplink channel at timing such as periodically, when a situation changes or when a report is requested from the base station BS.

The base station BS uses an OFDMA scheme on a downlink channel. The base station BS assigns a channel of each bearer to each of a plurality of users. The base station BS transmits a plurality of OFDM symbols in units of so-called “slots.” One slot includes various OFDM symbols of different objects and applications, such as pilot symbols for timing synchronization, pilot symbols for transmission path estimation, symbols in which data symbols, pilots and data are mixed. An arrangement pattern of symbols in one slot is called a “slot format” (see FIG. 3 which will be described later). One frame is made up of a plurality of slots.

The grouping section 8 in the base station receives user request data from each terminal through the user request extraction section 7. When the user request data is moving speed data, the grouping section 8 groups these user request data according to a predetermined threshold and thereby classifies each terminal under any one of a plurality of groups. For example, assuming the threshold is 60 km/h, the grouping section 8 classifies terminals having a moving speed equal to or higher than the threshold under a high-speed moving group and classifies terminals having a moving speed lower than the threshold under a low-speed moving group. In the example of FIG. 2, the terminal A and terminal B are classified under the high-speed moving group and the terminal C is classified under the low-speed moving group. On the other hand, when the user request data is group identifier data, the grouping section 8 classifies terminals under the group (low-speed moving group or high-speed moving group) associated with the group identifier data. When grouping is performed based on the group identifier data, there is an advantage that only a small amount of processing is required for the base station.

The grouping section 8 maintains a table which stores identifiers (names or IDs) of terminals belonging to the low-speed moving group and high-speed moving group. When a new terminal enters the cell range of a base station, the base station classifies the terminal under any one of the groups based on the user request data from the terminal after signaling with the terminal and registers the identifier of the terminal in the table. When user request data is received from a terminal which is already registered in the table, the base station judges whether or not the group of the terminal should be changed and updates the table if the group is changed. When the terminal moves out of the cell range, the identifier of the terminal is deleted from the table.

Here, the grouping section 8 has a table storing slot formats to be applied to the respective groups. A high-speed moving slot format is applied to the high-speed moving group (terminal A and terminal B) and a low-speed moving slot format is applied to the low-speed moving group (terminal C).

FIG. 3 shows examples of the high-speed moving slot format and low-speed moving slot format.

As a precondition, suppose one frame includes six slots and the number of OFDM symbols per slot is 10 and the number of subcarriers per OFDM symbol is 16. The high-speed moving slot format has an arrangement of pilot symbols including 1 synchronization pilot symbol and 2 transmission path estimation pilot symbols. The low-speed moving slot format has an arrangement including 1 synchronization pilot symbol and 1 transmission path estimation pilot symbol. Since the high-speed moving terminal is subject to high-speed fading fluctuation, deterioration in the accuracy of transmission path estimation is prevented by using the high-speed moving slot format with transmission path estimation pilots arranged also at some midpoint of the slot in addition to the start of the slot. On the other hand, since the low-speed moving terminal is not subject to so high-speed fading, deterioration of the transmission rate is prevented by using the low-speed moving slot format with only one transmission path estimation pilot arranged. In the high-speed moving slot format, instead of adding the above described 1-symbol transmission path estimation pilot or in addition thereto, it is also possible to add a mixed symbol in which transmission path estimation data and other data are mixed.

Here, the reason that the additional transmission path estimation pilot symbol has been added to the high-speed moving slot format will be explained as follows. Since the moving speed of the terminal A is 80 km/h, if the transmission frequency is assumed to be 2 GHz, a maximum Doppler frequency (=moving speed/transmission wavelength) is 80/3600/300000/2000000000=148.15 (Hz). 300000 (km/s) is an approximate value of the velocity of light. Likewise, a maximum Doppler frequency is calculated as 9.25 (Hz) for the terminal C. Since the maximum Doppler frequency is high for the high-speed moving group, even if transmission path estimation is performed at the start of the slot, the accuracy of transmission path correction drops if the transmission path fluctuates in the last half of the slot. Thus, by inserting a transmission path estimation pilot symbol at some midpoint of the slot and performing transmission path estimation once again, the deterioration of the accuracy of transmission path correction is prevented as much as possible.

After grouping the respective terminals, the grouping section 8 then calculates a total transmission rate required for each group and determines distribution of slots in 1 frame to each group. The number of slots having the same slot format in one frame is made to be approximately proportional to the total data transmission rate required by users who belong to each group.

Furthermore, the grouping section 8 also determines a channel to which a bearer of each terminal belonging to a group is assigned (subcarriers of each user may vary in symbol units) as channel information for each group.

Hereinafter, the method of determining the slot distribution to each group will be explained in detail with reference to FIG. 3 above.

Suppose the slot length is 0.5 ms. Suppose a case where the terminal A requests a transmission rate of 12 kbps for voice communication, the terminal B requests a transmission rate of 12 kbps for voice communication and 128 kbps for packet communication and the terminal C requests a transmission rate of 12 kbps for voice communication.

In this case, the total of the high-speed moving group (terminal A and terminal B) is 152 kbps (=12 kbps+12 kbps+128 kbps), while the total of the low-speed moving group (terminal C) is 12 kbps. Since the number of bits per frame necessary for each group is 76 bits for the high-speed moving group and 6 bits for the low-speed moving group, the slot distribution is, for example, 5 for the high-speed moving group and 1 for the low-speed moving group.

After determining the slot distribution for each group, the grouping section 8 notifies control data including an identifier of a slot format to be applied to each terminal, the position of a slot that each terminal should receive and channel information of each terminal to each terminal. This corresponds to the processing by the notification section.

For example, when the group to which a terminal belongs is changed, the terminal is notified of control data including an identifier of the changed slot format, information (group change information) including the changed slot position, changed channel information, using the channel (channel before the change) or control channel already assigned to the terminal. Then, the grouping section 8 updates the contents of the above described storage (e.g., information on the group to which the terminal belongs, channel information of the terminal or the like).

Furthermore, in the case where a terminal which has entered the cell of a base station has never been notified of the slot format or the like, that is, when a terminal has been newly grouped, control data including an identifier of the slot format of the group under which the terminal is classified, position of the slot assigned to the group and information on the channel assigned to the terminal is notified using control channel at a predetermined slot position. For example, assuming that a slot of a common slot format that can be received by all terminals is arranged at the start of the frame and the terminal receives only the start slot of the frame according to this common slot format, the above described control data is included in this start slot.

The slot format identification section 4 in the terminal receives the above described control data from the OFDM demodulate section 1. The slot format identification section 4 identifies the slot format from the slot format identifier included in the above described control data. The slot format identification section 4 stores information on the correspondence between slot format identifiers and slot formats beforehand. This information may be transmitted by the base station as part of control data to the terminal when the terminal moves into the cell range. The slot format identification section 4 notifies the OFDM demodulator 1 of the slot position and channel information included in the control data and the identified slot format.

The OFDM demodulator 1 performs OFDM demodulation processing based on the slot format, slot position and channel information notified from the slot format identification section 4. The OFDM demodulator 1 performs OFDM demodulation processing only for a period corresponding to the slot at the slot position notified from the slot format identification section 4. More specifically, the OFDM demodulator 1 performs an FFT on each OFDM symbol in this slot position, separates each OFDM symbol into a plurality of subcarriers and processes only subcarriers which belong to the channel to which the bearer used by itself is assigned (e.g., synchronization processing, transmission path estimation processing and demodulate processing). In the example of FIG. 3, the OFDM demodulators 1 of the terminal A and terminal B perform an FFT on the respective OFDM symbols included the respective slots of slot numbers 1 to 5 in the frame and processes subcarriers belonging to the channel to which the bearer used by itself is assigned. Likewise, the OFDM demodulator 1 of the terminal C performs an FFT for only a period corresponding to the slot of slot number 6 and processes subcarriers of the channel to which the bearer used by itself is assigned. Note that the terminal can also distinguish the symbol arrangement of the channel not used by itself from the slot format, and can thereby estimate a transmission path using transmission path estimation pilot data of the subcarriers belonging to the channel not used by itself.

As described above, according to this embodiment, a plurality of terminals are grouped according to their moving speeds and slot formats which vary from one group to another are applied, and therefore even when reception environments are different, each terminal can obtain a transmission rate suitable for its environment. For example, it is possible to avoid such a situation that transmission path estimation pilots are redundant for certain users, while transmission path estimation pilots are not enough for other users. Furthermore, this embodiment needs only to provide slot formats in group units instead of providing them for individual terminals and needs only information necessary for grouping as the feedback information to be sent from the terminals to the base station, and therefore this embodiment can be implemented using a simple algorithm.

### Second Embodiment

This embodiment is characterized by grouping terminals depending on whether the terminals require a long guard interval or only a normal guard interval. Hereinafter, this embodiment will be explained in detail.

In a cellular radio communication system, there are cases where only control data may be transmitted/received between a terminal and a base station, for example, at times of call out and call in. Such control data needs to be reliably delivered to the terminal, and therefore it does not require a high transmission rate but requires high reception accuracy (requires a low error rate). One of techniques to obtain high reception accuracy is to lengthen a guard interval of an OFDM symbol.

Thus, in this embodiment, terminals that transmit/receive control data are classifies under a long guard interval group which adopts a guard interval of an OFDM symbol longer than a normal guard interval and terminals that receive data (user data) other than control data are classified under a normal guard interval group which adopts a normal length for a guard interval of an OFDM symbol.

The long guard interval group is provided with a slot format defining an arrangement of fewer symbols than a normal guard interval (long guard interval slot format) and the normal guard interval group is provided with a slot format defining an arrangement of a normal number of symbols (normal guard interval slot format).

When performing OFDM modulation, an OFDM modulator 6 generates OFDM symbols having a long symbol length (having a long guard interval) for the group of the long guard interval slot format and generates OFDM symbols having a normal symbol length (having a normal-length guard interval) for the group of the normal guard interval slot format.

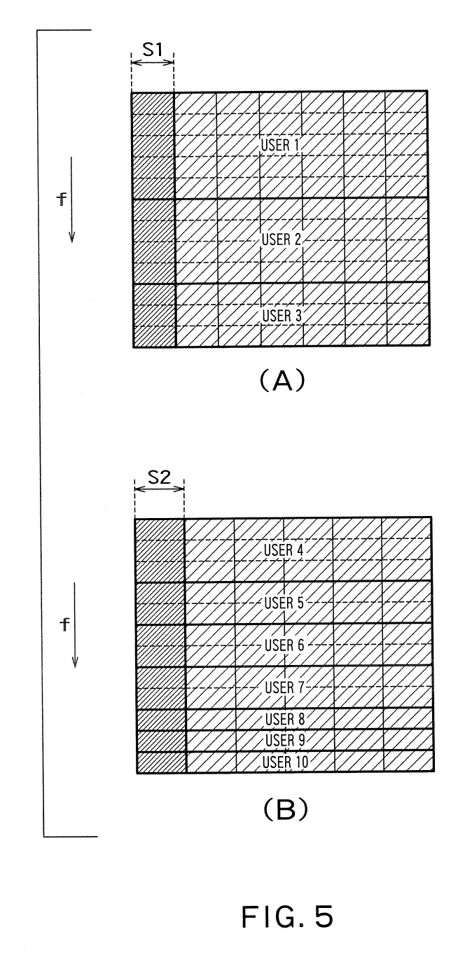

FIG. 5(A) shows an example of the normal guard interval slot format and FIG. 5(B) shows an example of the long guard interval slot format.

In FIG. 5(A), seven OFDM symbols having a symbol length S1 are arranged in one slot. In FIG. 5(B), six OFDM symbols having a symbol length S2 (>S1) which is longer than the symbol length S1 are arranged in one slot.

When transmitting user data, the base station secures a transmission rate by using the normal guard interval slot format shown in FIG. 5(A). On the other hand, when transmitting/receiving only control data to/from a terminal such as at times of call out or call in or when a terminal enters the base station area, the base station secures the reception accuracy using the long guard interval slot format shown in FIG. 5(B).

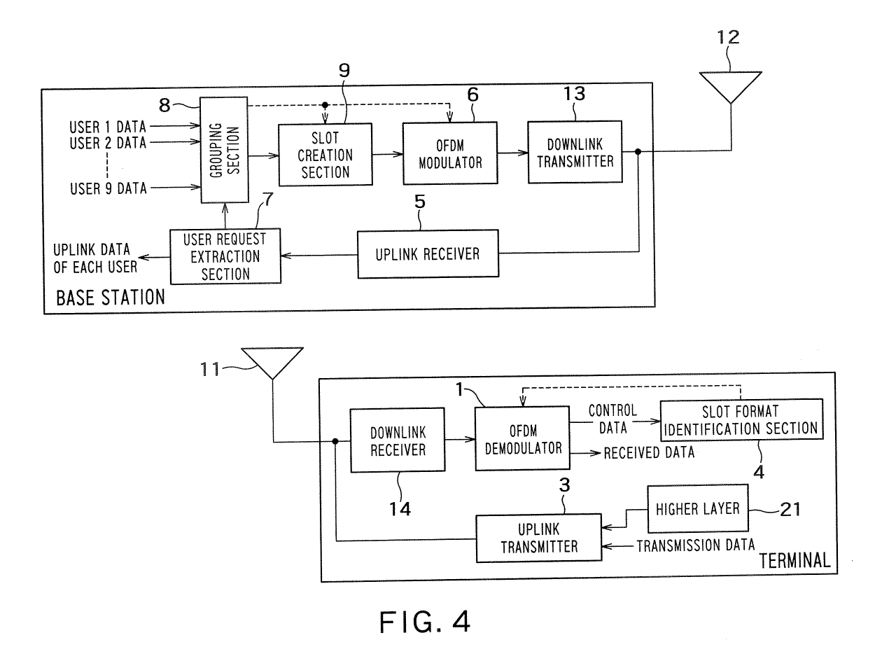

FIG. 4 shows the configuration of a cellular radio communication system according to a second embodiment of the present invention. Parts equivalent to those in FIG. 1 are assigned the same reference numerals, overlapping explanations of them will be omitted and explanations will be focused on points different from those in FIG. 1.

The terminal is provided with a higher layer 21 that executes a control procedure such as call out and call in. When establishing a connection with the base station, for example, the higher layer 21 transmits/receives control data using a control channel. Prior to this, the higher layer 21 may also transmit user request data (classification information) indicating that a control procedure will start to the base station. Furthermore, when ending transmission/reception of the control data and starting reception of user data, the higher layer 21 may also transmit user request data indicating that.

A grouping section 8 in the base station receives information on terminals that transmit/receive control data and information on terminals that receive user data from an application (not shown) in the base station. Alternatively, the base station receives user request data indicating the start of the above described control procedure and user request data indicating the start of reception of user data from the terminals.

The grouping section 8 in the base station groups terminals. The grouping section 8 classifies the terminals that transmit/receive only control data under the long guard interval group and classifies the terminals that receive user data under the normal guard interval group. Furthermore, the grouping section 8 passes information on a slot format (long guard interval slot format or normal guard interval slot format) used in each slot to the OFDM modulator 6.

The OFDM modulator 6 generates OFDM symbols having a long symbol length when the information inputted from the grouping section 8 indicates a long guard interval slot format and generates OFDM symbols having a normal guard interval slot format when the information indicates a normal guard interval slot format.

The above explanations have described an example where terminals are grouped depending on whether or not the terminals transmit/receive control data, but the present invention is not limited to this. In addition to control data, examples of data having a high degree of necessity for being received with high accuracy include encrypted password data and it is possible to group terminals depending on whether or not password data is received. That is, when the reception accuracy of password data is low, authentication errors are more liable to occur, causing deterioration of reliability of the system. Therefore, it is also effective to group terminals depending on whether or not password data is received.

As shown above, according to this embodiment, terminals are grouped depending on whether or not a long guard interval is necessary, and therefore each terminal can receive data having a preferable guard interval length. For example, terminals requiring a long guard interval classified under a long guard interval group can realize reliable communications with fewer errors, while terminals requiring only a normal guard interval classified under a normal guard interval group can realize communications at a high transmission rate.

### Third Embodiment

This embodiment is characterized by grouping terminals depending on whether each terminal is an MIMO terminal or non-MIMO terminal. Hereinafter, this embodiment will be explained in detail.

Suppose a case where terminals capable of receiving an MIMO (Multiple Input Multiple Output)-OFDM scheme signal (hereinafter referred to as “MIMO terminals”) and terminals incapable of receiving an MIMO signal (non-MIMO terminals) exist within the same cell range.

A synchronization pilot pattern of an MIMO terminal differs considerably from that of a non-MIMO terminal. That is, the number of synchronization pilot symbols for an MIMO terminal is greater than the number of synchronization pilot symbols for a non-MIMO terminal. Therefore, when an MIMO terminal and a non-MIMO terminal are mixed in the same slot, this means that pilot symbols which are redundant for the non-MIMO terminal are included in a slot, which prevents the non-MIMO terminal from carrying out optimum data transmission.

This embodiment groups terminals under an MIMO terminal group and a non-MIMO terminal group and provides the MIMO group with an MIMO slot format having an arrangement pattern of synchronization pilot symbols suitable for an MIMO scheme and provides the non-MIMO group with a non-MIMO slot format having an arrangement pattern of a synchronization pilot symbol for the non-MIMO.

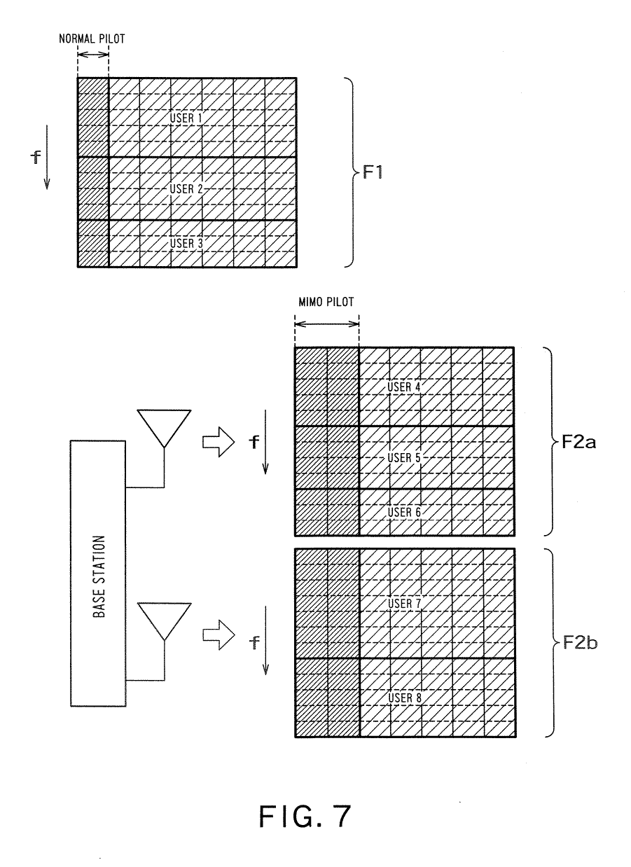

FIG. 7 shows examples of the non-MIMO slot format and MIMO slot format. F1 denotes the non-MIMO slot format and F2a and F2b denote the MIMO slot formats.

Here, suppose a case where there are non-MIMO terminals of user 1, user 2 and user 3 and MIMO terminals of user 4, user 5, user 6, user 7 and user 8 in an area of a base station. While only one synchronization pilot symbol is arranged in one slot according to the non-MIMO slot format, two synchronization pilot symbols are arranged in one slot according to the MIMO slot formats F2a, F2b, corresponding to the presence of two antennas in the base station. Thus, by changing a slot format to be applied depending on whether a terminal is an MIMO terminal or a non-MIMO terminal, it is possible to greatly reduce overhead of the system.

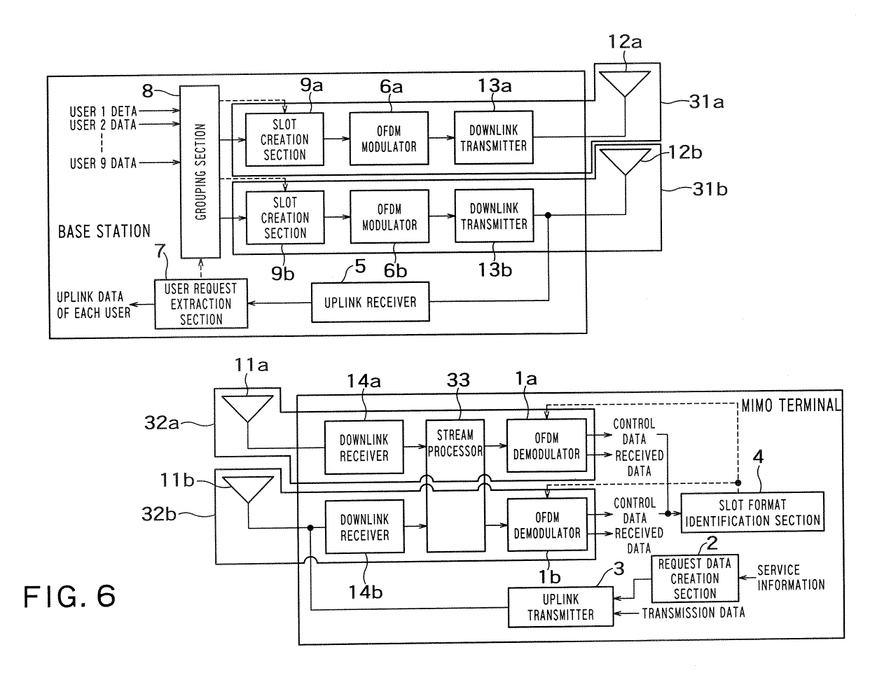

FIG. 6 shows the configuration of a cellular radio communication system according to a third embodiment of the present invention. Parts equivalent to those in FIG. 1 are assigned the same reference numerals and overlapping explanations of them will be omitted and explanations will be focused on points different from those in FIG. 1.

This cellular radio communication system is provided with a base station, an MIMO terminal and a non-MIMO terminal, but since the non-MIMO terminal is the same as that in FIG. 1, it is not shown.

The base station has N (≧2) transmission lines and this embodiment shows a case with N=2, that is, two transmission lines 31a, 31b. The transmission lines 31a, 31b have slot creation sections 9a, 9b, OFDM modulators 6a, 6b, downlink transmitters 13a, 13b and antennas 12a, 12b. When performing transmission to the MIMO terminals, the respective transmission lines modulate different data and transmit the modulated signals with the same frequency band. That is, two signal lines are transmitted simultaneously from the two antennas 12a, 12b in the same frequency band. When performing transmission to the non-MIMO terminals, transmission is performed using any one of the transmission lines 31a, 31b.

The MIMO terminal has M (≧1) reception lines and this embodiment shows a case with M=2, that is, two transmission lines 32a, 32b. The reception lines 32a, 32b include antennas 11a, 11b, downlink receivers 14a, 14b and OFDM demodulators la, lb. A stream processor 33 is commonly included in the two reception lines 32a, 32b, and the downlink receivers 14a, 14b and OFDM demodulators 1a, 1b are connected to the stream processor 33 on the input side and output side of the stream processor 33 respectively. The stream processor 33 obtains two signal lines transmitted from the base station based on signals received simultaneously from the antennas 11a, 11b using a spatial filtering scheme, maximum likelihood estimation scheme or ordered successive decoding scheme or the like. The signal line from the transmission line 31a is inputted to the OFDM demodulator 1a and the signal line from the transmission line 31b is inputted to the OFDM demodulator 1b.

When starting a communication with the base station, the terminal notifies the base station as to whether the own terminal is a non-MIMO terminal or MIMO terminal. More specifically, a request data creation section 2 passes service information indicating whether the terminal is an MIMO terminal or non-MIMO terminal as user request data (classification information) to an uplink transmitter 3. The uplink transmitter 3 transmits the user request data together with other transmission data (e.g., control data) to the base station through the antenna 11b. It is also possible to transmit, only when the terminal is an MIMO terminal, user request data indicating that the terminal is an MIMO terminal to the base station and transmit nothing when the terminal is a non-MIMO terminal, or vice versa.

A user request extraction section 7 in the base station extracts user request data from the received signals through an uplink receiver 5 and passes it to a grouping section 8. The grouping section 8 classifies non-MIMO terminals under the non-MIMO group and MIMO terminals under the MIMO group based on the user request data. The grouping section 8 puts slot format identifiers, positions of slots to be received and channel information in control data and transmits the control data to terminals which belong to each group using a predetermined slot such as a start slot of a frame on a downlink.

When carrying out transmission to MIMO terminals, the grouping section 8 passes an MIMO slot format that matches the MIMO scheme (e.g., F2a, F2b in FIG. 7) to the slot creation sections 9a, 9b. When carrying out transmission to non-MIMO terminals, the grouping section 8 passes a non-MIMO slot format (e.g., F1 in FIG. 7) to the slot creation section 9a or 9b in the transmission line used.

The stream processor 33 in the MIMO terminal obtains two signal lines from the signals simultaneously received through the antenna 32a, 32b and inputs one to the OFDM demodulator 1a and the other to the OFDM demodulator 1b. The OFDM demodulators 1a, 1b perform a fast Fourier transform only for a period corresponding to each slot position notified from a slot format identification section 4, separate each OFDM symbol into a plurality of subcarriers and process (synchronization, transmission path estimation, demodulation or the like) subcarriers which belong to a channel assigned to the own terminal according to the slot format (see F2a and F2b in FIG. 7). The control data obtained through demodulation is passed to the slot format identification section 4 or protocol software and the user data (received data) is passed to application software.

As shown above, according to this embodiment, it is possible to easily realize bearer channel assignment in a cellular radio communication system in which MIMO terminals and non-MIMO terminals are mixed and reduce overhead of the system due to the mixture of both types of terminals.

It is naturally possible to combine the above described embodiment with the first embodiment or second embodiment. For example, when this embodiment is combined with the first embodiment, grouping according to a moving speed is performed for the MIMO group and non-MIMO group respectively and the respective terminals are classified under any one of a plurality of sub groups (e.g., high moving speed group and low moving speed group). For the terminals which belong to the MIMO group, it is possible to apply a slot format satisfying features of each sub group (e.g., high moving speed and low moving speed) and a synchronization pilot pattern of the MIMO scheme.

What is claimed is:

1. A cellular radio communication system in which an OFDMA (Orthogonal Frequency Division Multiple Access) scheme is used for communication from a base station to radio terminals,
the base station comprising:
a reception section configured to receive classification information for classifying the radio terminals respectively under any one of a plurality of groups from the radio terminals;
a group determining section configured to determine groups under which the radio terminals are to be classified based on the classification information received;
a channel determining section configured to determine frequency channels to assign to the radio terminals;
a slot distribution section configured to distribute slots which are time frame of constant length to the groups;
a slot format storage configured to store slot formats for the groups, defining an arrangement of at least one pilot symbol for synchronization, at least one pilot symbol for transmission path estimation and data symbols for transmitting transmission data;
a notification section configured to notify each of the radio terminals of control information representing a slot format of the group under which the radio terminal is classified, the frequency channel assigned to the radio terminal and positions of slots distributed to the group under which the radio terminal is classified;
a slot creation section configured to create slot data at each slot position, including a plurality of symbol based on transmission data directed to radio terminals which belong to the group to which the slot position is assigned, information of the frequency channels assigned to the radio terminals in the group, data for synchronization specified beforehand, data for the transmission path estimation specified before hand and a slot format associated with the group;
an OFDM modulation section configured to OFDM-modulate the respective symbols included in the slot data created to generate a plurality of OFDM symbols; and
a transmission section configured to transmit the plurality of OFDM symbols as OFDM slot data, and
the radio terminal comprising:
a classification information creation section configured to create the classification information;
a transmission section configured to transmit the classification information created to the base station;
a control information acquisition section configured to acquire the control information from the base station;
a reception section configured to receive the OFDM slot data from the base station; and
an OFDM demodulation section configured to perform a fast Fourier transform on the respective OFDM symbols in the OFDM slot data received at slot positions indicated in the control information to separate the each OFDM symbol into a plurality of subcarriers, and carry out synchronization processing, transmission path estimation processing and demodulation processing according to the slot format indicated in the control information using subcarriers which belong to the frequency channel indicated in the control information.

2 The system according to claim 1, wherein
the radio terminal further comprises a moving speed detecting section configured to detect a moving speed,
the classification information creation section in the radio terminal creates moving speed data indicating the moving speed detected as the classification information, and
the group determining section in the base station determines a group under which the radio terminal should be classified based on the moving speed indicated in the moving speed data.

3. The system according to claim 2, wherein the slot format of a high moving speed group defines an arrangement of more pilot symbols for transmission path estimation than the slot format of a low moving speed group.

4. The system according to claim 1, wherein
the classification information creation section in the radio terminal determines a group to which the radio terminal should belong and creates identifier data for identifying the group determined as the classification information, and
the group determining section in the base station classifies the radio terminal under a group shown by the identifier data.

5. The system according to claim 1, wherein
a slot format of a first group defines an arrangement of a first number of symbols in total and a slot format of a second group defines an arrangement of a second number of symbols smaller than the first number of symbols in total, and
the OFDM modulation section in the base station generates OFDM symbols having a first guard interval length for the first group and generates OFDM symbols having a second guard interval length longer than the first guard interval length for the second group.

6. The system according to claim 1, wherein
the group determining section classifies each radio terminal under any one group of an MIMO group and a non-MIMO group and
a slot format of the MIMO group defines an arrangement of pilot symbols for synchronization compliant with an MIMO scheme.

7. The system according to claim 1, wherein
the control information includes an identifier for identifying a slot format as the information representing the slot format, and
the control information acquisition section in the radio terminal stores correspondence between identifiers and slot formats and notifies the OFDM demodulation section of a slot format corresponding to an identifier included in the control information.

8. The system according to claim 1, wherein the group determining section in the base station calculates a total of transmission rates requested by the respective radio terminals per group and distributes slots to groups based on the calculation result.

9. The system according to claim 1, wherein
the group determining section in the base station judges whether or not to change a group to which the radio terminal should belong based on the classification information received, and determines a group under which the radio terminal is to be classified and a frequency channel to assign to the radio terminal in a case that change of the group is determined and
the notification section in the base station notifies the radio terminal of control information representing the slot format of the changed group, a channel assigned to the radio terminal and positions of slots of the changed group.

10. A base station which uses OFDMA (Orthogonal Frequency Division Multiple Access) scheme for communication to radio terminals, comprising:
a reception section configured to receive classification information for classifying the radio terminals respectively under any one of a plurality of groups from the radio terminals;
a group determining section configured to determine groups under which the radio terminals are to be classified based on the classification information received;
a channel determining section configured to determine frequency channels to assign to the radio terminals;
a slot distribution section configured to distribute slots which are time frame of constant length to the groups;
a slot format storage configured to store slot formats for the groups, defining an arrangement of at least one pilot symbol for synchronization, at least one pilot symbol for transmission path estimation and data symbols for transmitting transmission data;
a notification section configured to notify each of the radio terminals of control information representing a slot format of the group under which the radio terminal is classified, the frequency channel assigned to the radio terminal and positions of slots distributed to the group under which the radio terminal is classified;
a slot creation section configured to create slot data at each slot position, including a plurality of symbol based on transmission data directed to radio terminals which belong to the group to which the slot position is assigned, information of the frequency channels assigned to the radio terminals in the group, data for synchronization specified beforehand, data for the transmission path estimation specified before hand and a slot format associated with the group;
an OFDM modulation section configured to OFDM-modulate the respective symbols included in the slot data created to generate a plurality of OFDM symbols; and
a transmission section configured to transmit the plurality of OFDM symbols as OFDM slot data.

11. The base station according to claim 10, wherein
the reception section receives moving speed data representing a moving speed of the radio terminal as the classification information,
the group determining section determines a group under which the radio terminal should be classified based on the moving speed indicated in the moving speed data.

12. The base station according to claim 11, wherein the slot format of a high moving speed group defines an arrangement of more pilot symbols for transmission path estimation than the slot format of a low moving speed group.

13. The base station according to claim 10, wherein
the reception section receives identifier data for identifying a group to which the radio terminal belongs, as the classification information, and
the group determining section classifies the radio terminal under a group shown by the identifier data.

14. The base station according to claim 10, wherein
a slot format of a first group defines an arrangement of a first number of symbols in total and a slot format of a second group defines an arrangement of a second number of symbols smaller than the first number of symbols in total, and
the OFDM modulation section generates OFDM symbols having a first guard interval length for the first group and generates OFDM symbols having a second guard interval length longer than the first guard interval length for the second group.

15. The base station according to claim 10, wherein
the group determining section classifies each radio terminal under any one group of an MIMO group and a non-MIMO group and
a slot format of the MIMO group defines an arrangement of pilot symbols for synchronization compliant with an MIMO scheme.

16. The base station according to claim 10, wherein the group determining section calculates a total of transmission rates requested by the respective radio terminals per group and distributes slots to groups based on the calculation result.

17. The base station according to claim 10, wherein
the group determining section judges whether or not to change a group to which the radio terminal should belong based on the classification information received,
determines a group under which the radio terminal is to be classified and a frequency channel to assign to the radio terminal in a case that change of the group is determined, and
the notification section notifies the radio terminal of control information representing the slot format of the changed group, a frequency channel assigned to the radio terminal and positions of slots of the changed group.

18. A radio terminal which uses OFDMA (Orthogonal Frequency Division Multiple Access) scheme for communication from a base station, comprising:
a classification information creation section configured to create classification information for requesting classifying into any one of a plurality of group;
a transmission section configured to transmit the classification information created to the base station;
a reception section configured to receive OFDM slot data as a plurality of OFDM symbols from the base station; and
a control information acquisition section configured to acquire control information from the base station, wherein the control information indicates (A) a slot format associated with a group classified into by the base station which defines an arrangement of at least one pilot symbol for synchronization, at least one pilot symbol for transmission path estimation and data symbols for transmitting transmission data, (B) a frequency channel assigned by the base station, and (C) positions of slots which are time frame of constant length, distributed to said group;
an OFDM demodulation section configured to perform a fast Fourier transform on the respective OFDM symbols in the OFDM slot data received at slot positions indicated in the control information to separate the each OFDM symbol into a plurality of subcarriers respectively, and carry out synchronization processing, transmission path estimation processing and demodulation processing according to the slot format indicated in the control information using subcarriers which belong to the frequency channel indicated in the control information.

19. The radio terminal according to claim 18, further comprising a moving speed detecting section configured to detect a moving speed, wherein
the classification information creation section creates moving speed data indicating the moving speed detected as the classification information.

20. The radio terminal according to claim 18, wherein
the classification information creation section determines a group to be classified into among the plurality of groups, and creates identifier data for identifying the group determined as the classification information.

21. The radio terminal according to claim 18, wherein
the control information includes an identifier for identifying a slot format as the information representing the slot format, and
the control information acquisition section stores correspondence between identifiers and slot formats and notifies the OFDM demodulation section of a slot format corresponding to an identifier included in the control information.

22. A radio communication method in which an OFDMA (Orthogonal Frequency Division Multiple Access) scheme is used for communication from a base station to radio terminals, comprising:
transmitting classification information for classifying the radio terminals respectively under any one of a plurality of groups from the radio terminals to the base station;
determining groups under which the radio terminals are to be classified based on the classification information;
determining frequency channels to assign to the radio terminals;
distributing slots which are time frame of constant length to the groups;
notifying each of the radio terminals of the control information representing a slot format of the group under which the radio terminal is classified, the channel assigned to the radio terminal and positions of slots distributed to the group under which the radio terminal is classified, wherein the slot format defines an arrangement of at least one pilot symbol for synchronization, at least one pilot symbol for transmission path estimation and data symbols for transmitting transmission data;
creating slot data including a plurality of symbol in each slot position based on transmission data directed to radio terminals which belong to the group to which the slot position is assigned, information of the frequency channel assigned to radio terminals in the group, data for synchronization specified beforehand, data for the transmission path estimation specified before hand, and a slot format associated with the group;
OFDM-modulating the respective symbols included in the slot data to generate a plurality of OFDM symbols;
transmitting the plurality of OFDM symbols as OFDM slot data, from the base station to the radio terminals belonging to the group;
receiving the OFDM slot data transmitted from the base station at radio terminals;
receiving the control information transmitted from the base station at radio terminals;
performing a fast Fourier transform on the respective OFDM symbols in the OFDM slot data at slot positions indicated in the control information to separate the each OFDM symbol into a plurality of subcarriers; and
carrying out synchronization processing, transmission path estimation processing and demodulation processing according to the slot format indicated in the control information using subcarriers which belong to the frequency channel indicated in the control information.

23. The method according to claim 22, further comprising:
judging whether or not to change a group to which the radio terminal should belong based on the classification information;
determining a group under which the radio terminal is to be classified and a frequency channel to assign to the radio terminal in a case that change of the group is determined and;
notifying the radio terminal of control information representing the slot format of the changed group, a frequency channel assigned to the radio terminal and positions of slots of the changed group.
